(19) United States
(12) Patent Application Publication
(10) Pub. No.: US 2026/0303221 A1
(43) Pub. Date: Oct. 1, 2026

(54) OPTICAL TRANSMITTER WITH QUAD-WIRE DIFFERENTIAL OPTICAL MODULATOR AND DRIVER

(71) Applicant: Ciena Corporation, Hanover, MD (US)

(72) Inventors: Susanne Paul, Austin, TX (US); Christopher Daunt, Vasteras (SE); Jonathan Proesel, Mount Vernon, NY (US)

(21) Appl. No.: 19/576,757

(22) Filed: Mar. 24, 2026

Related U.S. Application Data
(60) Provisional application No. 63/778,846, filed on Mar. 27, 2025.

(51) Int. Cl. H04B 10/548; H04B 10/2581; H04B 10/50

(52) U.S. Cl. CPC H04B 10/548; H04B 10/2581; H04B 10/505

(57) ABSTRACT

Optical-modulation methods and apparatus. In one example, an apparatus includes an electrical driver configured to generate a first and second differential pairs of modulated drive signals in response to a data stream. The first pair includes first and second modulated electrical signals. The second pair includes third and fourth modulated electrical signals. The apparatus also includes an optical phase shifter including a first optical waveguide core and a second optical waveguide core. Each of the first and second optical waveguide cores includes a respective cathode side and a respective anode side joined to form a respective electrical diode. Each of the first, second, third, and fourth modulated electrical signals is applied to drive a respective one of the cathode and anode sides of the first and second optical waveguide cores.

### CROSS-REFERENCE TO RELATED APPLICATIONS

This application claims the benefit of U.S. Provisional Patent Application No. 63/778,846, filed on 27-Mar-2025, and entitled “QUAD-WIRE DIFFERENTIAL OPTICAL MODULATOR DRIVER,” the contents of which are incorporated herein by reference.

### FIELD OF THE DISCLOSURE

Various example embodiments relate to optical communication equipment and, more specifically but not exclusively, to driving circuitry for optical modulators.

### BACKGROUND

An optical modulator driver is an electronic device that amplifies and shapes electrical signals to drive an optical modulator, allowing for the modulation of optical signals, e.g., in fiberoptic communication systems.

### BRIEF SUMMARY OF SOME SPECIFIC EMBODIMENTS

Various examples provide optical-modulation methods and apparatus. Some driver and optical modulator configurations disclosed herein enable the application of respective data-modulated electrical drive signals to both anode and cathode sides of each of two optical waveguide cores implemented using lateral semiconductor p-n junctions, with the two optical waveguide cores being connected in a Mach-Zehnder configuration. This feature beneficially leads to a more significant phase change and improved modulation efficiency. Consequently, a shorter modulator length can achieve a selected target extinction ratio, resulting in a reduced insertion loss and/or a lower device cost.

In one example, an optical transmitter comprises: an electrical driver configured to generate a first differential pair of modulated drive signals and a second differential pair of modulated drive signals in response to a data stream, the first pair including first and second modulated electrical signals, the second pair including third and fourth modulated electrical signals; and an optical modulator including a first optical waveguide core and a second optical waveguide core, each of the first and second optical waveguide cores including a respective cathode side and a respective anode side joined to form a respective electrical diode, wherein each of the first, second, third, and fourth modulated electrical signals is applied to drive a respective one of the cathode side of the first optical waveguide core, the anode side of the first optical waveguide core, the cathode side of the second optical waveguide core, and the anode side of the second optical waveguide core.

In another example, an optical communication method comprises: providing an electrical driver for generating a first differential pair of modulated drive signals and a second differential pair of modulated drive signals in response to a data stream, the first pair including first and second modulated electrical signals, the second pair including third and fourth modulated electrical signals; and configuring the electrical driver to apply the first, second, third, and fourth modulated electrical signals to an optical modulator including a first optical waveguide core and a second optical waveguide core, each of the first and second optical waveguide cores including a respective cathode side and a respective anode side joined to form a respective electrical diode, wherein each of the first, second, third, and fourth modulated electrical signals is applied to a respective one of the cathode side of the first optical waveguide core, the anode side of the first optical waveguide core, the cathode side of the second optical waveguide core, and the anode side of the second optical waveguide core.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 is a block diagram illustrating an optical transmitter according to some examples.

FIG. 2 is a schematic diagram illustrating a cross-sectional view of a phase shifter that can be used in the optical transmitter of FIG. 1 according to some examples.

FIG. 3 is a schematic diagram illustrating an optoelectronic circuit that can be used to modify the optical transmitter of FIG. 1 according to some examples.

FIG. 4 graphically illustrates differential signal pairs generated in the optoelectronic circuit of FIG. 3 according to some examples.

FIG. 5 is a schematic diagram illustrating an optoelectronic circuit that can be used to modify the optical transmitter of FIG. 1 according to some additional examples.

FIG. 6 is a schematic diagram illustrating a cross-sectional view of the optical modulator used in the optoelectronic circuit of FIG. 5 according to some examples.

FIG. 7 is a schematic diagram illustrating an optoelectronic circuit that can be used to modify the optical transmitter of FIG. 1 according to some further examples.

### DETAILED DESCRIPTION

Example embodiments disclosed herein pertain to electrical integrated circuits engineered to deliver electrical signals to semiconductor optical modulators. Such modulators can be used, e.g., in optoelectronic systems, including systems and devices used in telecommunications, spectroscopy, and signal processing. Some examples focus on improvements to electrical circuits for applying electrical signals to optical modulators, aiming to enhance electrooptical gain and efficiency while attempting to nearly minimize the total optical loss in the modulator.

Mach-Zehnder Modulators (MZMs) are important devices in the field of photonics, which are used, e.g., for modulating optical signals within integrated photonic circuits. Such modulators operate based on the principles of interference, leveraging the Mach-Zehnder interferometer structure to manipulate the phase and intensity of transmitted light. In a representative example, an MZM has two waveguide arms that split from a common input waveguide and recombine at a common output waveguide. The modulation process begins with an input light signal being divided into two arms by a beam splitter. Each arm (or path) contains a respective phase shifter, such as a p-n or PIN junction, which modulates the phase of the light passing through in response to an applied electrical signal. When the light beams from the two arms are recombined at the output, the interaction between the modulated light waves results in constructive or destructive interference, thereby modulating the intensity of the output light signal.

MZMs are widely used in various photonic systems due to their high-speed modulation capabilities and good compatibility with various photonic materials platforms. For example, MZMs are used as components in various above-mentioned optical-modulator applications. However, in some applications, legacy MZMs may face challenges that can impact their performance, including limitations in modulation efficiency, bandwidth, and/or insertion loss. To address some of those challenges, advancements in driver-circuit design are being actively pursued. Some electrical amplifiers used to apply amplified signals to the MZMs can be set up in a single-ended or differential configuration, where either both anodes or both cathodes of the two MZM arms are modulated. Some driver configurations disclosed herein enable the application of a modulated signal to both sides of each lateral waveguide diode. This approach may beneficially lead to a more significant phase change and improved modulation efficiency. Consequently, a shorter modulator length can achieve a selected target electrooptic gain and/or extinction ratio (ER), resulting in a reduced loss and/or a lower cost.

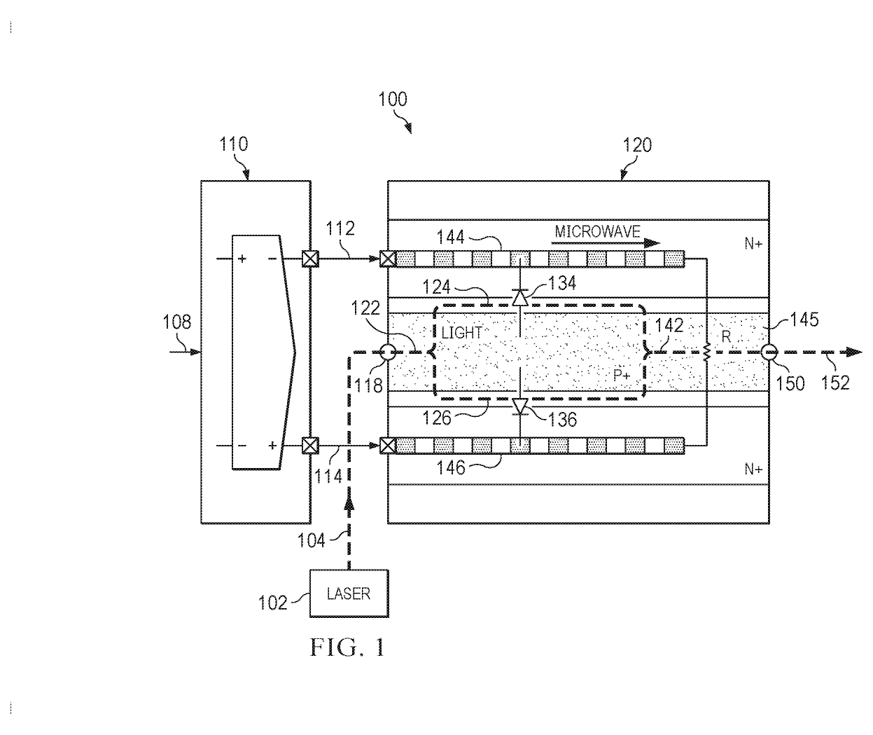

FIG. 1 is a block diagram illustrating an optical transmitter 100 according to some examples. The optical transmitter 100 includes a laser 102, an electrical driver 110, and an optical modulator 120. The laser 102 operates to generate an optical beam 104 which is applied to an optical input port 118 of the optical modulator 120. In some examples, the optical beam 104 is a continuous wave (CW) beam. In the example shown, the electrical driver 110 operates to generate electrical drive signals 112, 114 for driving the optical modulator 120 in response to an input data stream 108. In some additional examples, the electrical driver 110 may be configured to generate one or more than two electrical drive signals. In response to the electrical drive signals 112, 114, the optical modulator 120 modulates the optical beam 104, thereby generating a modulated optical signal 152 having encoded therein the input data stream 108. The modulated optical signal 152 exits the optical modulator 120 through an optical output port 150.

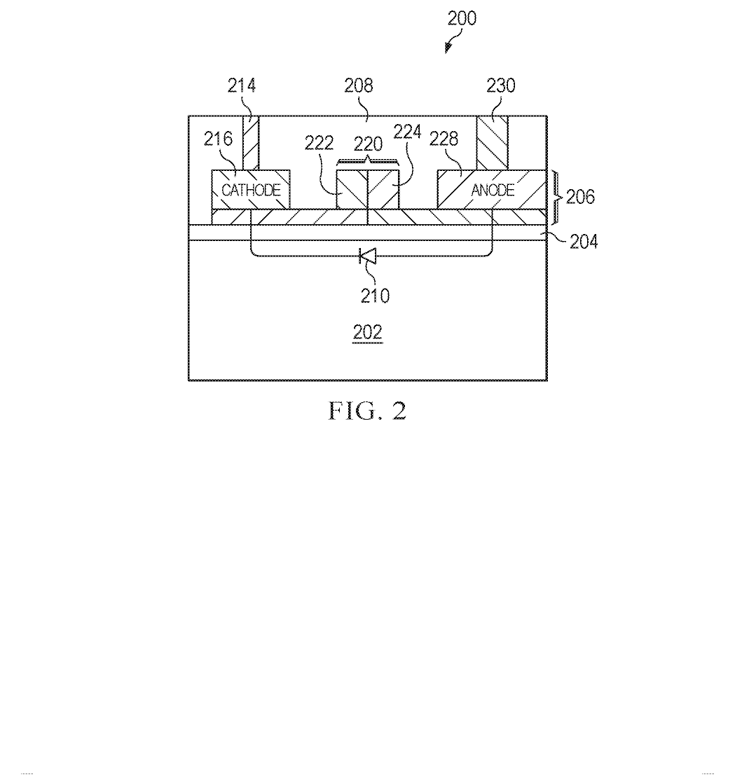

In the example shown, the optical modulator 120 comprises a depletion-mode silicon-based MZM constructed using variously doped regions of silicon (also see FIG. 2). An example depletion-mode silicon-based MZM can beneficially provide high modulation speed and broadband optical spectra and exhibit relatively high thermal stability, which qualify such modulators as a preferred choice for robust fiber communication systems. In other examples, other (than silicon-based) material platforms can also be used to implement the optical modulator 120 or a functional equivalent thereof.

For example, long haul fiber communication systems may use high performance devices fabricated using LiNbO₃ or III-V compounds, such as InP. In general, longer distance data communications may rely on larger modulation depth (or ER). Some LiNbO₃ modulators provide extinction ratios greater than 13 dB, making them a good choice for kilometer-reach or longer fiberoptic links. On the other hand, intra-data-center communications use medium-reach links covering distances in the approximate range of 100-1000 m, with a preference for relatively low power, relatively high-density integration, and relatively low cost. In that regard, silicon photonics is an attractive technology that may enable energy-efficient, high-bandwidth, and low-cost interconnects in next-generation datacenters. In addition, being based on mature CMOS technology, silicon photonics lends itself to efficient integration of more functions on a single chip, such as data-clock recovery and digital signal processing.

The optical modulator 120 includes an optical Y-splitter 122 coupled between the optical input port 118 and the modulator arms 124, 126. In some examples, the optical Y-splitter 122 is a 3-dB splitter configured to split the optical beam 104 received through the optical input port 118 into two attenuated copies, with the first copy being directed into the modulator arm 124 and the second copy being directed into the modulator arm 126. The modulator arms 124 and 126 are driven to impose phase modulation on the light passing therethrough and electrically present themselves as diodes 134 and 136, respectively, e.g., as schematically indicated in FIG. 1 (also see FIG. 2). The diodes 134 and 136 are driven using the electrical drive signals 112 and 114, respectively, as further indicated in FIG. 1. The optical modulator 120 further includes an optical Y-combiner 142 coupled between the modulator arms 124, 126 and the optical output port 150. The optical Y-combiner 142 operates to combine the phase-modulated light received from the modulator arms 124, 126, thereby generating the modulated optical signal 152. In some examples, the optical Y-combiner 142 is a nominal copy of the optical Y-splitter 122 configured to pass light in the reverse propagation direction.

In the example shown, the optical modulator 120 further includes traveling-wave (TW) electrodes 144 and 146 connected to receive the electrical drive signals 112 and 114, respectively. In some examples, each of the TW electrodes 144, 146 is implemented using a respective transmission line (T-line), e.g., a coplanar waveguide (CPW), which runs from the corresponding electrical input port to a matched impedance resistor R. This design may present several benefits. For example, by integrating the electrode’s capacitive loading into the T-line, the effective electrical bandwidth may be broadened. With the capacitance not substantially limiting the bandwidth, it becomes possible to implement a longer phase shifter, e.g., several millimeters in length, capable of achieving a larger optical ER. In addition, a matched-impedance transmission line and termination can absorb potential reflections in the high-speed signal path. Furthermore, the electrical (microwave) and optical (light) propagation velocities can be matched in a relatively straightforward manner without significant changes to the overall circuit design.

In some additional examples, each of the TW electrodes 144, 146 may be replaced by a respective segmented electrode (SE). In effect, the resulting SE MZM utilizes multiple short-length phase shifters (e.g., each shorter than one-tenth of the wavelength) connected in series. Unlike the TW MZM, which uses a single driver, the SE topology uses the same number of drivers as the number of segments. For some applications, the SE architecture may offer some benefits. For example, dividing the TW electrode into segments allows the modulator to be represented as an array of lumped capacitors. Charging these capacitors needs significantly less power compared to energizing a low-impedance transmission line, thereby enabling the use of smaller voltage-mode drivers for modulation. Furthermore, because the driving capability is no longer constrained by the transmission line’s length, more segments can be cascaded to achieve larger phase shifts. As a result, for a given phase shift, drivers with smaller voltage swings may be used, allowing for a reduced driver size, which may be especially beneficial for implementations based on deep sub-micron technologies.

In some examples, the TW MZM design may be preferred for pairing with drivers capable of a relatively high voltage-swing. In some additional examples, the SE MZM design may be preferred for heterogeneous or monolithic integration, which substantially moves the circuit complexity to the electrical driver circuit capable of a smaller voltage swing and larger scale integration.

FIG. 2 is a schematic diagram illustrating a cross-sectional view of an optical phase shifter 200 that can be used in the optical modulator 120 according to some examples. More specifically, a respective instance of the phase shifter 200 may be used to implement each one of the modulator arms 124, 126. In the example shown, the phase shifter 200 is implemented using a SOI (Silicon‑On‑Insulator) wafer and includes a handle layer (substrate) 202, a buried oxide (BOX) layer 204, and a device layer 206. The substrate 202 is a relatively thick (typically silicon) layer that provides mechanical support. The BOX layer 204 is an insulating layer, typically silicon dioxide (SiO₂), that electrically isolates the device layer 206 from the substrate 202. The device layer 206 is a relatively thin, high‑quality single‑crystal silicon layer where pertinent device structures are formed.

The phase shifter 200 includes a ridge waveguide core 220 formed in the device layer 206. The core 220 has an n-doped region 222 and a p-doped region 224, which form a lateral p-n junction. The p-n junction 222/224 can be electrically biased using a first electrode 216 (acting as a cathode) and a second electrode 228 (acting as an anode) and electrically presents itself as a diode 210. The diode 210 is an example of either one of the diodes 134 and 136 illustrated in FIG. 1. The first and second electrodes 216 and 228 can be electrically connected to an external voltage/current source (such as the electrical driver 110, FIG. 1) via electrical contacts 214 and 230, respectively. An interlayer dielectric 208 provides electrical insulation between the electrodes and different traces of the metal interconnect. In addition, portions of the interlayer dielectric 208 adjacent to the ridge waveguide core 220 serve as a cladding of the corresponding optical waveguide.

When a voltage is applied between the cathode 216 and the anode 228, the effective refractive index of the semiconductor material of the ridge waveguide core 220 is altered through carrier injection or depletion modulation, thereby enabling control over the phase of light passing through the optical waveguide. In the example shown, the p-n junction 222/224 has a depletion region near the center of the ridge waveguide core 220 or, in some cases, slightly off-center. When the diode 210 is reverse-biased, it sweeps carriers out of the junction, causing the depletion region to widen. As the depletion region increasingly overlaps with the optical mode, it enhances the refractive index modulation and reduces optical losses, by reducing the free carrier absorption.

Referring back to FIG. 1, to drive the diodes 134 and 136, electrical AC-modulated signals and proper DC biasing are provided by the electrical driver 110. In examples involving InP or LiNbO₃ MZMs with III-V driver links, the driver may be configured to provide ~7 V or ~8 V for the VPP voltage swing, where VPP denotes the total voltage swing between the highest and lowest points of a waveform. However, in at least some use cases, such a single-ended drive scheme may not be compatible with CMOS-based drivers, e.g., due to the lower supply voltage VDD (i.e., the positive power‑supply rail of the circuit) and possible breakdown stress. Therefore, to maintain a reasonable ER, the phase shifter’s effective length may need to be increased. As such, a push-pull topology of the modulator may be beneficial. The underlying idea of the push-pull configuration is that by driving both arms in opposite phases, the effective phase shift is doubled around a common-mode level. In some examples, a single-ended output driver may be used to achieve a push-pull configuration by driving one arm’s anode and the other arm’s cathode simultaneously, while also applying suitable VDD and GND (ground) DC biases.

In some examples, a differential driver may be configured to output to both arm’s anodes. Since their cathodes are tied to the highest DC voltage, reverse-biasing is well guaranteed in such examples. In the example shown in FIG. 1, a common DC bias electrode 145 is used for the anodes of the diodes 134, 136. In some additional examples, the DC bias electrode 145 can be split into two separate anode electrodes. In further examples, two separate drive circuits may be used for both arms, with their differential outputs being applied on both terminals of the diode. To guarantee reverse biasing, one of the drivers may be configured to operate in a higher voltage domain, such as VDD to 2 VDD, providing a DC-shifted output swing. In this configuration, the voltage swing across each diode is effectively doubled. Additionally, due to the effective double length of the push-pull, there may be a fourfold improvement in the phase shift.

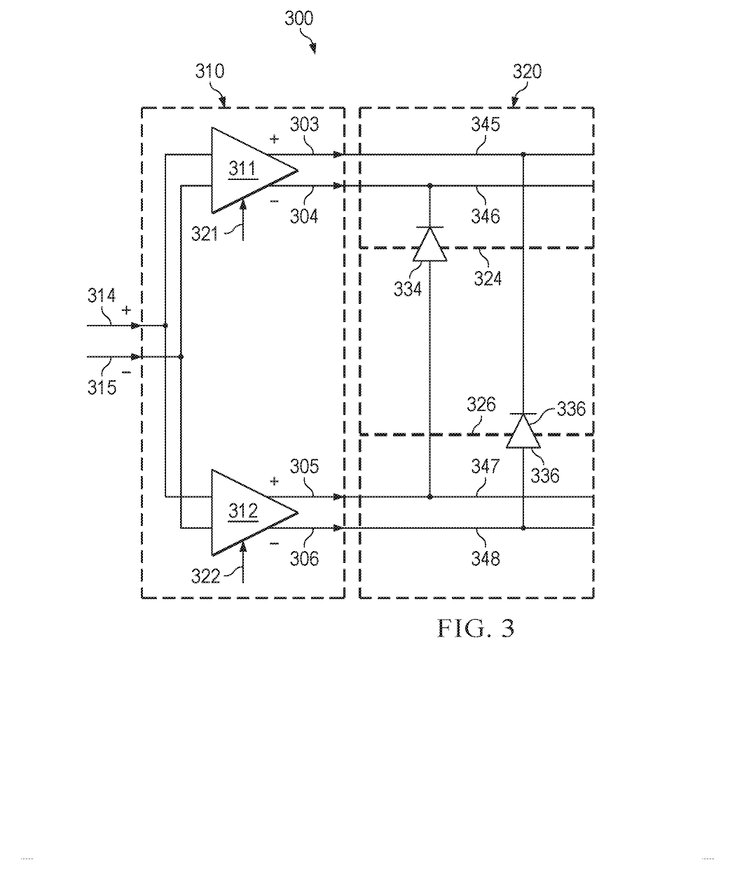

At least some of the above-outlined considerations may be practically realized using example circuit designs and driving schemes described in more detail below in reference to FIGS. 3-7.

FIG. 3 is a schematic diagram illustrating an optoelectronic circuit 300 that can be used to modify the optical transmitter 100 according to some examples. More specifically, the optoelectronic circuit 300 includes an electrical driver 310 that replaces the electrical driver 110 (also see FIG. 1). The optoelectronic circuit 300 further includes an optical modulator 320 that replaces a portion of the optical modulator 120. The resulting modified optical transmitter inherits from the optical transmitter 100 at least the following components: (i) the laser 102; (ii) the optical Y-splitter 122; and (iii) the optical Y-combiner 142, which are not explicitly shown in FIG. 3 for better clarity of depiction of the pertinent electrical configuration. The optical Y-splitter 122 and the optical Y-combiner 142 are end-connected to optical waveguide cores 324 and 326 of the optical modulator 320 to form an MZM interferometer structure that is analogous to the MZM interferometer structure of the optical modulator 120 described above in reference to FIG. 1. The optical waveguide cores 324 and 326 may be implemented similar to the ridge waveguide core 220 (FIG. 2) and electrically present themselves as diodes 334 and 336, respectively.

The electrical driver 310 is connected to receive a differential input signal pair 314, 315, copies of which are applied to the corresponding inputs of driver circuits 311 and 312. In response to the differential input signal pair 314, 315, the driver circuit 311 operates to generate a first differential output signal pair (303, 304) having a DC bias voltage set by an input voltage 321. Similarly, the driver circuit 312 operates to generate a second differential output signal pair (305, 306) having a DC bias voltage set by an input voltage 322. The DC bias voltage levels for the signals 303-306 are selected such that the diodes 334 and 336 remain in reverse bias during modulation.

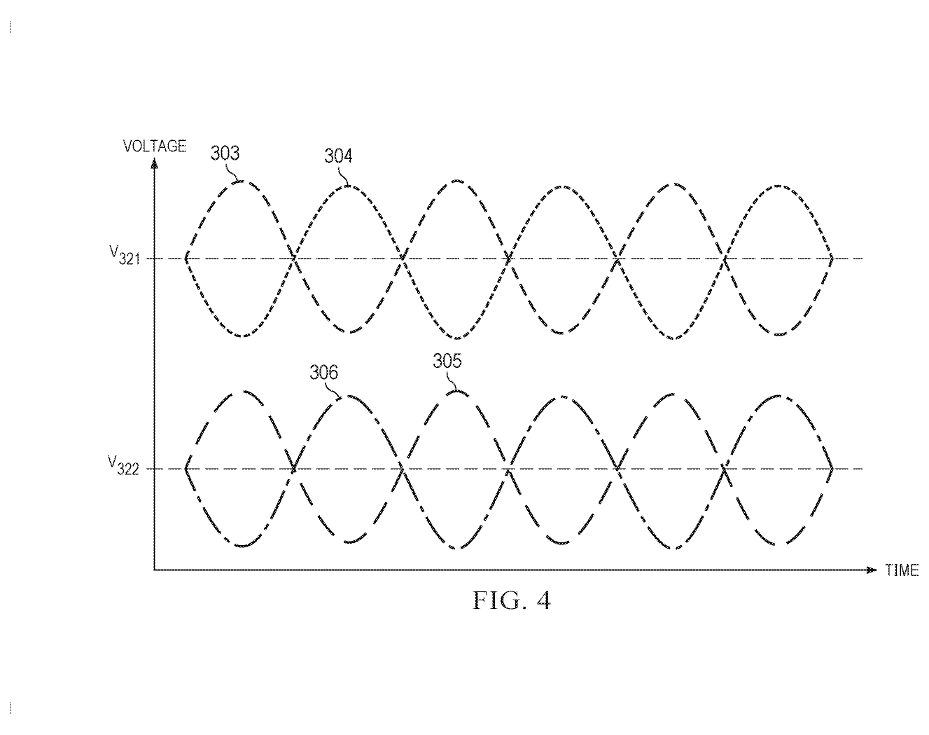

FIG. 4 graphically illustrates the signals 303-306 according to some examples. In the example shown, the signals 303-306 are generated by the electrical driver 310 in response to the differential input signal pair 314, 315 carrying sine waveforms. In other examples, other suitable modulation waveforms may similarly be used. Such modulation waveforms may include, for example, pulse trains, ramp waves, and/or rectangular waves.

Marked on the vertical axis in FIG. 4 are the DC bias voltage levels V₃₂₁and V₃₂₂ representing the input voltages 321 and 322, respectively (also see FIG. 3). The diode 334 receives the signals 304 and 305 at the cathode electrode 216 and the anode electrode 228 thereof, respectively (also see FIG. 2). The diode 336 receives the signals 303 and 306 at the cathode electrode 216 and the anode electrode 228 thereof, respectively. The DC bias voltage levels V₃₂₁ and V₃₂₂ are selected such that the signals 304 and 305 do not cross, thereby maintaining the diode 334 in reverse bias at all times. Similarly, the DC bias voltage levels V₃₂₁ and V₃₂₂ cause no crossing for the signals 303 and 306, thereby maintaining the diode 336 in reverse bias at all times as well.

Recall that, in one example configuration, the optical modulator 120 (FIG. 1) is configured to receive two (data-)modulated cathode signals, i.e., the signals 112 and 114, and one DC signal at the common anode electrode 145 of the diodes 134, 136. In contrast, the optical modulator 320 of FIG. 3 is configured to receive four (data-)modulated signals 303-306 and does not receive a separate DC signal. The diodes 334 and 336 are distributed along the lengths of the optical waveguide cores 324 and 326, and the voltage applied across their terminals determines the amount of modulation applied to the light passing therethrough. These voltages are carried along the length of transmission line conductors 345-348 in the above-described TW configuration. The transmission line conductors 345-348 are terminated at the end of the modulator and have their inductance and capacitance chosen to present a broadband matched impedance to the driver circuits 311 and 312 so that microwave reflections are substantially minimized.

Due to the AC signal swing being presented at both anode and cathode terminals of each of the diodes 334, 336, the modulator driving scheme implemented in the optoelectronic circuit 300 can achieve twice as much modulation depth per unit of voltage as that achieved in the optical transmitter 100. This aspect of the modified optical transmitter may be beneficial when voltage swings in the electrical driver are limited, for example, due to the use of a fine process node and/or inherently low power supply voltages in CMOS implementations. Another difference between the optical transmitter 100 of FIG. 1 and the modified optical transmitter employing the optoelectronic circuit 300 is that in the latter there are four TW signals (i.e., the signals 303-306) that traverse the length of the modulator along the T-line conductors 345-348, whereas in the former there are only two such TW signals. Yet another difference between the optical transmitter 100 of FIG. 1 and the modified optical transmitter employing the optoelectronic circuit 300 is that the electrical driver 310 generates two differential signal pairs with different respective DC bias levels (e.g., see the levels V₃₂₁ and V₃₂₂ in FIG. 4) whereas the electrical driver 110 generates only one such differential signal pair.

Although, as shown in FIG. 3, the electrical driver 310 has two separate driver circuits (amplifiers) 311 and 312, various embodiments are not so limited. For example, in some embodiments, the amplifiers 311, 312 may be combined into a single amplifier that generates as its output both the anode and cathode differential signal pairs. In further embodiments, other suitable amplifier arrangements may also be used to generate the anode and cathode differential signal pairs for the optical modulator 320.

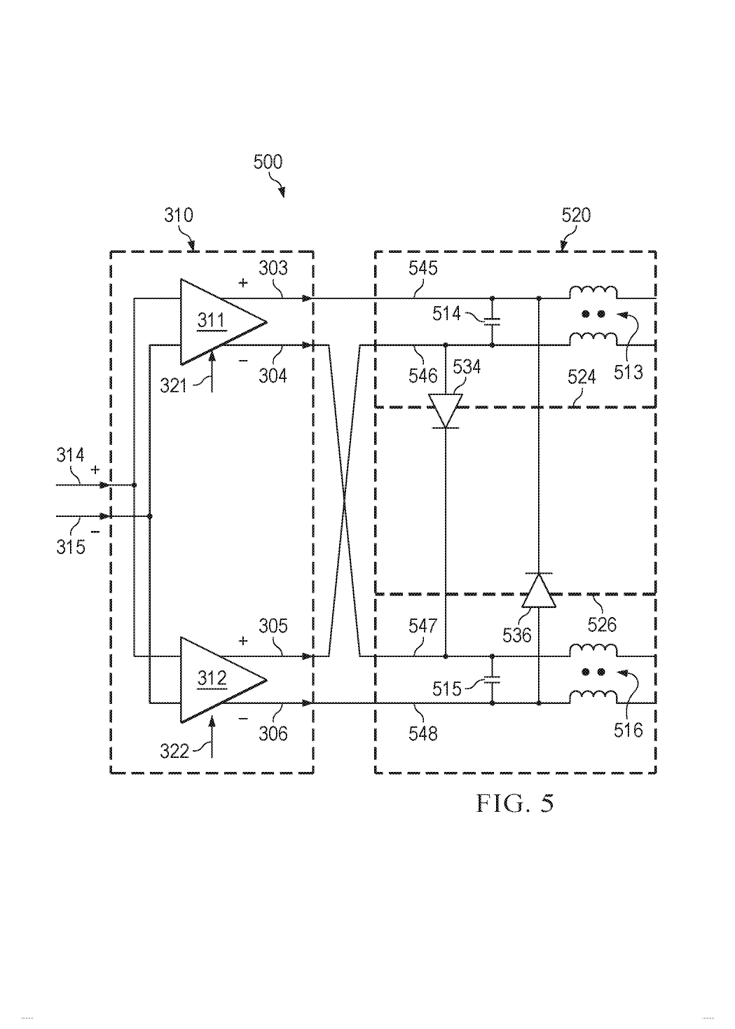

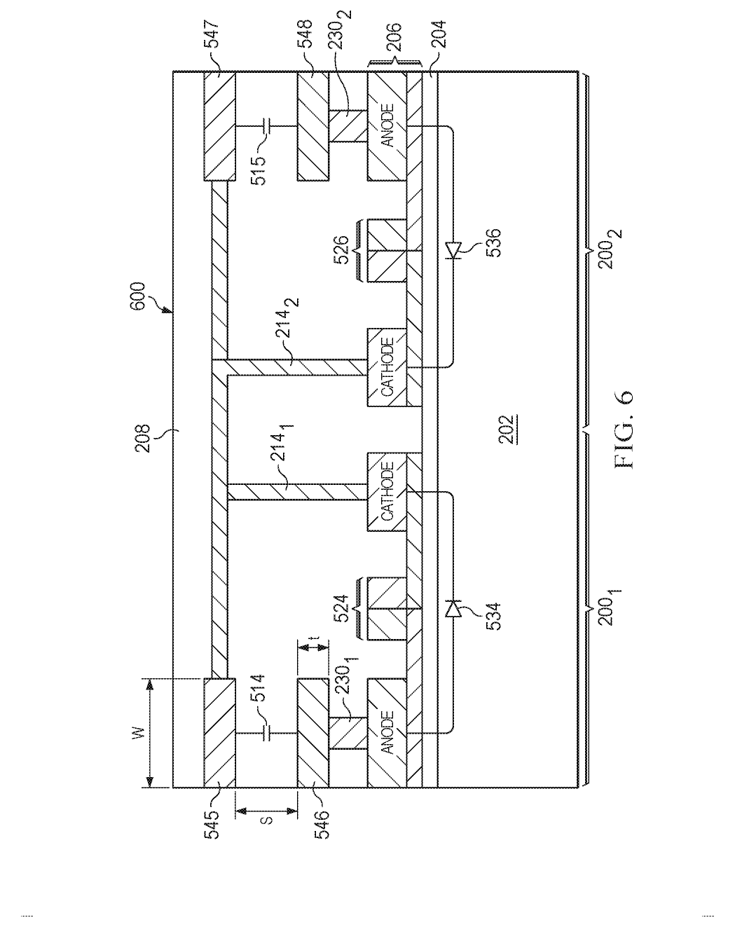

FIG. 5 is a schematic diagram illustrating an optoelectronic circuit 500 that can be used to modify the optical transmitter 100 according to some additional examples. More specifically, the optoelectronic circuit 500 includes the above-described electrical driver 310 that replaces the electrical driver 110 (also see FIG. 1). The optoelectronic circuit 300 further includes an optical modulator 520 that replaces a portion of the optical modulator 120. The resulting modified optical transmitter inherits from the optical transmitter 100 at least the following components: (i) the laser 102; (ii) the optical Y-splitter 122; and (iii) the optical Y-combiner 142, which are not explicitly shown in FIG. 5 for better clarity of depiction of the pertinent electrical configuration. The optical Y-splitter 122 and the optical Y-combiner 142 are end-connected to optical waveguide cores 524 and 526 of the optical modulator 520 to form an MZM interferometer structure that is analogous to the MZM interferometer structure of the optical modulator 120 described above in reference to FIG. 1. The optical waveguide cores 524 and 526 may be implemented similar to the ridge waveguide core 220 (FIG. 2; also see FIG. 6) and electrically present themselves as diodes 534 and 536, respectively.

The optical modulator 520 differs from the optical modulator 320 (FIG. 3) in that, in the optical modulator 520, each pair (545/546 and 547/548) of adjacent T-line conductors carries in-phase TW signals whereas, in the optical modulator 320, each pair (345/346 and 347/348) of adjacent T-line conductors carries counter-phase TW signals. More specifically, the T-line conductor pair 545/546 carries the positive differential signals 303 and 305, whereas the T-line conductor pair 345/346 carries one positive differential signal 303 and one negative differential signal 304 (also see FIG. 4). Similarly, the T-line conductor pair 547/548 carries the two negative differential signals 304 and 306, whereas the T-line conductor pair 347/348 carries one positive differential signal 305 and one negative differential signal 306. We note that the T-line impedance is set by the capacitance of the diodes and the separation between the positive group and the negative group, which determines the inductance of the lines. The in-phase nature of the adjacent (neighboring) lines allows them to be either capacitively coupled (as indicated in FIG. 5 by capacitors 514 and 515) or inductively coupled (as indicated in FIG. 5 by inductive couplers 513 and 516), or to be both capacitively and inductively coupled.

To reduce undesired crosstalk between the adjacent T-lines, the interline capacitances 514 and 515 and the mutual inductances 513 and 516 are taken into consideration during the design process and are tuned to minimize excitement of undesired cross modes. In some examples, such tuning may be performed by changing one or more of the following design parameters: (i) the width of one or both of the adjacent T-line conductors; (ii) the thickness of one or both of the adjacent T-line conductors; and (iii) the separation between the adjacent T-line conductors. In some additional examples, resistive elements can be incorporated to dissipate the undesired cross modes.

We further note that the amplifiers 311, 312 produce outputs containing respective differential-mode components and common-mode components. In some examples, the common mode component may represent an undesired mode. In such examples, further improvements can be achieved in the embodiment illustrated in FIG. 5 by making the common mode signals produced by the amplifiers 311, 312 to be of opposite signs (polarities), thereby inducing effective cancellation of the common mode when those signals are combined in the modulator.

FIG. 6 is a schematic diagram illustrating a cross-sectional view 600 of the optical modulator 520 according to some examples. In the example shown, each of the two phase shifters of the optical modulator 520 is implemented using a respective instance of the phase-shifter 200 (also see FIG. 2). Accordingly, the two phase shifters shown in FIG. 6 are labeled using the reference numerals 200₁and 200₂. The ridge waveguide core 220 of the phase shifter 200₁ implements the optical waveguide core 524. The ridge waveguide core 220 of the phase shifter 200₂ similarly implements the optical waveguide core 526. The phase shifters 200₁and 200₂ are arranged such that the cathode side of the phase shifter 200₁faces the cathode side of the phase shifter 200₂. For comparison, in a similar implementation of the optical modulator 320 (FIG. 3), the phase shifters 200₁and 200₂ would be arranged such that the anode side of the phase shifter 200₁would face the cathode side of the phase shifter 200₂.

The electrical contacts 214₁and 230₁of the phase shifter 200₁are connected to the T-line conductors 547 and 546, respectively. The electrical contacts 214₂and 230₂of the phase shifter 200₂are similarly connected to the T-line conductors 545 and 548, respectively. The T-line conductors 545 and 546 are stacked vertically at the anode side of the phase shifter 200₁. The corresponding inter-line capacitance is electrically represented by the capacitor 514. The T-line conductors 547 and 548 are similarly stacked vertically at the anode side of the phase shifter 200₂. The corresponding inter-line capacitance is electrically represented by the capacitor 515.

During the above-mentioned design optimization directed at reducing undesired cross-talk, the following design parameters may be tuned: (i) the respective width W of one or both of the adjacent T-line conductors; (ii) the respective thickness t of one or both of the adjacent T-line conductors; and (iii) the separation S between the adjacent T-line conductors. For illustration purposes, these parameters are indicated in FIG. 6 only for the T-line conductors 546 and 547. In various examples, the different T-line conductors may have (i) different respective thicknesses t or the same thickness and (ii) different respective widths W or the same width. The vertical separation S between the adjacent T-line conductors may be the same or different in the phase shifters 200₁and 200₂.

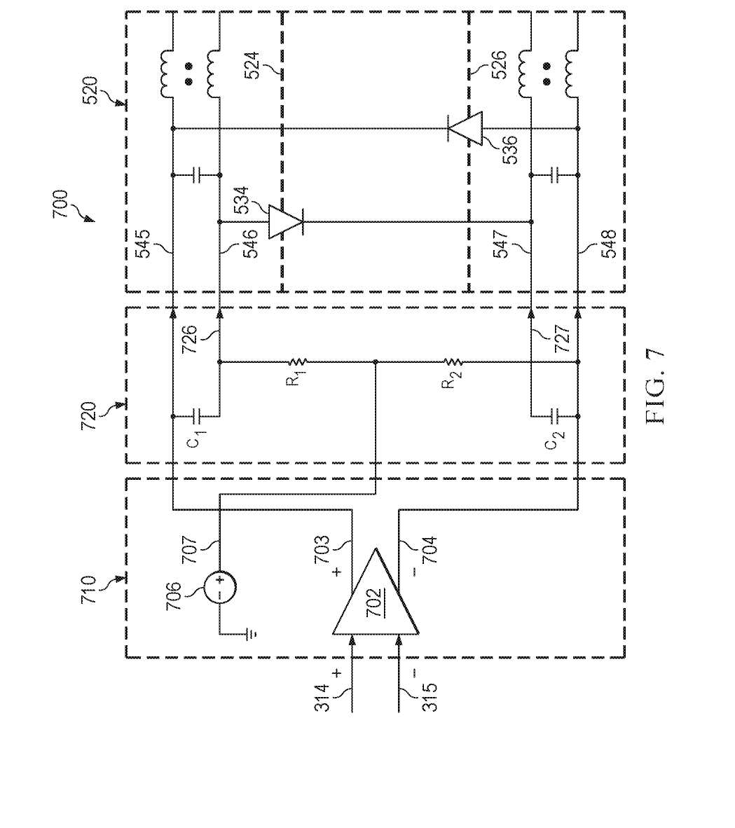

FIG. 7 is a schematic diagram illustrating an optoelectronic circuit 700 that can be used to modify the optical transmitter 100 according to some further examples. More specifically, the optoelectronic circuit 500 includes the above-described optical modulator 520 that replaces a portion of the optical modulator 120. The optoelectronic circuit 300 further includes an electrical driver 710 and an adapter 720 that replace the electrical driver 110 (also see FIG. 1). The resulting modified optical transmitter inherits from the optical transmitter 100 at least the following components: (i) the laser 102; (ii) the optical Y-splitter 122; and (iii) the optical Y-combiner 142, which are not explicitly shown in FIG. 7 for better clarity of depiction of the pertinent electrical configuration. The optical Y-splitter 122 and the optical Y-combiner 142 are end-connected to the optical waveguide cores 524 and 526 of the optical modulator 520 to form an MZM interferometer structure that is analogous to the MZM interferometer structure of the optical modulator 120 described above in reference to FIG. 1. The optical waveguide cores 524 and 526 may be implemented similar to the ridge waveguide core 220 (FIG. 2; also see FIG. 6) and electrically present themselves as diodes 534 and 536, respectively.

Taken together, the electrical driver 710 and the adapter 720 are functionally analogous to the electrical driver 310 (also see FIGS. 3, 5). A driver circuit (amplifier) 702 in the electrical driver 710 receives (data-)modulated input signals 314 and 315 and generates one differential output signal pair 703 and 704. The adapter 720 then operates to transfer the signals 703 and 704 to the T-line conductors 545 and 548, respectively, in the optical modulator 520. The electrical driver 710 also includes a programmable DC voltage source 706 that generates a DC voltage 707. The adapter 720 includes a resistor bridge constructed using resistors R₁and R₂, which are serially connected between the T-line conductors 546 and 548 in the optical modulator 520, with the DC voltage 707 being applied in the resistor bridge between those resistors. The adapter 720 further includes capacitors C₁ and C₂ end-connected to the resistor bridge R₁-R₂ as indicated in FIG. 7. More specifically, the capacitor C₁ is connected between the T-line conductors 545 and 546, and the capacitor C₂ is connected between the T-line conductors 547 and 548. The resistor R₁and the capacitor C₁operate to condition the signals 703 and 707 to generate a corresponding modulated signal 726, which is applied to the T-line conductor 546. The resistor R₂ and the capacitor C₂ similarly operate to condition the signals 704 and 707 to generate a corresponding modulated signal 727, which is applied to the T-line conductor 547. In some examples, the capacitors C₁ and C₂ have a relatively large capacitance to provide relatively strong coupling at low frequencies. Due to the capacitive coupling provided by the capacitors C₁ and C₂, the effective voltage swing presented to the anodes of the diodes 534 and 536 will increase with increasing frequency, which creates a net frequency upslope to the modulator response. In at least some use cases, such frequency upslope is a desirable characteristic that can be used to compensate for the frequency roll-off elsewhere in the signal paths.

According to an example embodiment disclosed above, e.g., in the summary section and/or in reference to any one or any combination of some or all of FIGS. 1-7, provided is an apparatus comprising: an electrical driver configured to generate a first differential pair of modulated drive signals and a second differential pair of modulated drive signals in response to a data stream, the first pair including first and second modulated electrical signals, the second pair including third and fourth modulated electrical signals; and an optical modulator including a first optical waveguide core and a second optical waveguide core, each of the first and second optical waveguide cores including a respective cathode side and a respective anode side joined to form a respective electrical diode, wherein each of the first, second, third, and fourth modulated electrical signals is applied to drive a respective one of the cathode side of the first optical waveguide core, the anode side of the first optical waveguide core, the cathode side of the second optical waveguide core, and the anode side of the second optical waveguide core.

In some embodiments of the above apparatus, the first and second optical waveguide cores are connected to one another using an optical splitter and an optical combiner to form a Mach-Zehnder interferometer structure; and wherein the apparatus further comprises a laser configured to apply a light beam to the optical splitter for transmission through the first and second optical waveguide cores.

In some embodiments of any of the above apparatus, the first, second, third, and fourth modulated electrical signals are configured to drive the Mach-Zehnder interferometer structure in a push-pull configuration.

In some embodiments of any of the above apparatus, the first differential pair of modulated drive signals has a first DC bias; and wherein the second differential pair of modulated drive signals has a different second DC bias.

In some embodiments of any of the above apparatus, the first DC bias and the different second DC bias are selected such that the respective electrical diodes remain reverse-biased during modulation.

In some embodiments of any of the above apparatus, the optical modulator further includes first, second, third, and fourth transmission line conductors disposed along the first and second optical waveguide cores and configured to drive the first and second optical waveguide cores in a travelling-wave configuration.

In some embodiments of any of the above apparatus, the optical modulator comprises a planar substrate; wherein the first and second optical waveguide cores are disposed along the planar substrate; and wherein the first and second transmission line conductors are stacked vertically with respect to the planar substrate such that the first transmission line conductor is at a first offset distance with respect to the planar substrate and the second transmission line conductor is at a different second offset distance with respect to the planar substrate.

In some embodiments of any of the above apparatus, the first modulated electrical signal is in-phase with the third modulated electrical signal; wherein the first transmission line conductor is connected to carry the first modulated electrical signal; and wherein the second transmission line conductor is connected to carry the third modulated electrical signal.

In some embodiments of any of the above apparatus, the third and fourth transmission line conductors are stacked vertically with respect to the planar substrate such that the third transmission line conductor is at the first offset distance with respect to the planar substrate and the fourth transmission line conductor is at the different second offset distance with respect to the planar substrate.

In some embodiments of any of the above apparatus, the first modulated electrical signal is in-phase with the third modulated electrical signal; wherein the second modulated electrical signal is in-phase with the fourth modulated electrical signal; wherein the first and third modulated electrical signals are counter-phase with the second and fourth modulated electrical signals; wherein the first transmission line conductor is connected to carry the first modulated electrical signal; wherein the second transmission line conductor is connected to carry the third modulated electrical signal; wherein the third transmission conductor line is connected to carry the second modulated electrical signal; and wherein the fourth transmission line conductor is connected to carry the fourth modulated electrical signal.

In some embodiments of any of the above apparatus, the cathode side of the first optical waveguide core faces the cathode side of the second optical waveguide core.

In some embodiments of any of the above apparatus, the cathode side of the first optical waveguide core faces the anode side of the second optical waveguide core.

In some embodiments of any of the above apparatus, the anode side of the first optical waveguide core faces the anode side of the second optical waveguide core.

In some embodiments of any of the above apparatus, the electrical driver includes a first capacitor and a second capacitor, the first capacitor being connected between the first and second transmission line conductors, the second capacitor being connected between the third and fourth transmission line conductors; and wherein the first and second capacitors have respective capacitance values selected to at least partially compensate for a frequency roll-off in the optical modulator.

In some embodiments of any of the above apparatus, the electrical driver further includes a resistor bridge connected between the second and third transmission line conductors.

In some embodiments of any of the above apparatus, the first modulated electrical signal is applied to drive the cathode side of the second optical waveguide core; wherein the second modulated electrical signal is applied to drive the cathode side of the first optical waveguide core; wherein the third modulated electrical signal is applied to drive the anode side of the first optical waveguide core; and wherein the fourth modulated electrical signal is applied to drive the anode side of the second optical waveguide core.

In some embodiments of any of the above apparatus, the first modulated electrical signal is in-phase with the third modulated electrical signal; wherein the second modulated electrical signal is in-phase with the fourth modulated electrical signal; wherein the first and third modulated electrical signals are counter-phase with the second and fourth modulated electrical signals; wherein the second and third modulated electrical signals are applied to the cathode and anode sides, respectively, of the first optical waveguide core; and wherein the first and fourth modulated electrical signals are applied to the cathode and anode sides, respectively, of the second optical waveguide core.

According to another example embodiment disclosed above, e.g., in the summary section and/or in reference to any one or any combination of some or all of FIGS. 1-7, provided is an optical communication method comprising: providing an electrical driver for generating a first differential pair of modulated drive signals and a second differential pair of modulated drive signals in response to a data stream, the first pair including first and second modulated electrical signals, the second pair including third and fourth modulated electrical signals; and configuring the electrical driver to apply the first, second, third, and fourth modulated electrical signals to an optical modulator including a first optical waveguide core and a second optical waveguide core, each of the first and second optical waveguide cores including a respective cathode side and a respective anode side joined to form a respective electrical diode, wherein each of the first, second, third, and fourth modulated electrical signals is applied to a respective one of the cathode side of the first optical waveguide core, the anode side of the first optical waveguide core, the cathode side of the second optical waveguide core, and the anode side of the second optical waveguide core.

In some embodiments of the above method, the optical modulator further includes: first, second, third, and fourth transmission line conductors disposed along the first and second optical waveguide cores and configured to drive the first and second optical waveguide cores in a travelling-wave configuration; and a planar substrate; wherein the first and second optical waveguide cores are disposed along the planar substrate; and wherein the first and second transmission line conductors are stacked vertically with respect to the planar substrate such that the first transmission line conductor is at a first offset distance with respect to the planar substrate and the second transmission line conductor is at a different second offset distance with respect to the planar substrate.

In some embodiments of any of the above methods, the method further comprises selecting one or more of the following design parameters to substantially minimize cross-mode excitation in the first and second transmission line conductors: a width of one or both of the first and second transmission line conductors; a thickness of one or both of the first and second transmission line conductors; and vertical separation between the first and second transmission line conductors.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Any numerical range recited herein includes all values from the lower value to the upper value. For example, if a range is stated as 1% to 50%, it is intended that the narrower ranges thereof, such as 2% to 40%, 10% to 30%, 1% to 3%, etc., are expressly enumerated by said statement. These specific examples represent only a limited subset of what is intended to be covered, and all possible combinations of numerical values between and including the lowest value and the highest value of the enumerated range are to be considered to be expressly stated in this application. Concentration ranges, pH ranges, and other ranges of specific parameters are intended to be interpreted in a manner similar to the “%” example.

The modifier “about” or “approximately” used in connection with a quantity is inclusive of the stated value and has the meaning dictated by the context (for example, it includes at least the degree of error associated with the measurement of the particular quantity). The modifier “about” or “approximately” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so that, for example, “about 1” may also mean from 0.5 to 1.4.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

What is claimed is:

1. An apparatus, comprising:
an electrical driver configured to generate a first differential pair of modulated drive signals and a second differential pair of modulated drive signals in response to a data stream, the first pair including first and second modulated electrical signals, the second pair including third and fourth modulated electrical signals; and
an optical modulator including a first optical waveguide core and a second optical waveguide core, each of the first and second optical waveguide cores including a respective cathode side and a respective anode side joined to form a respective electrical diode,
wherein each of the first, second, third, and fourth modulated electrical signals is applied to drive a respective one of the cathode side of the first optical waveguide core, the anode side of the first optical waveguide core, the cathode side of the second optical waveguide core, and the anode side of the second optical waveguide core.

2. The apparatus of claim 1,
wherein the first and second optical waveguide cores are connected to one another using an optical splitter and an optical combiner to form a Mach-Zehnder interferometer structure; and
wherein the apparatus further comprises a laser configured to apply a light beam to the optical splitter for transmission through the first and second optical waveguide cores.

3. The apparatus of claim 2, wherein the first, second, third, and fourth modulated electrical signals are configured to drive the Mach-Zehnder interferometer structure in a push-pull configuration.

4. The apparatus of claim 1,
wherein the first differential pair of modulated drive signals has a first DC bias; and
wherein the second differential pair of modulated drive signals has a different second DC bias.

5. The apparatus of claim 4, wherein the first DC bias and the different second DC bias are selected such that the respective electrical diodes remain reverse-biased during modulation.

6. The apparatus of claim 1, wherein the optical modulator further includes first, second, third, and fourth transmission-line conductors disposed along the first and second optical waveguide cores and configured to drive the first and second optical waveguide cores in a travelling-wave configuration.

7. The apparatus of claim 6,
wherein the optical modulator comprises a planar substrate;
wherein the first and second optical waveguide cores are disposed along the planar substrate; and
wherein the first and second transmission-line conductors are stacked vertically with respect to the planar substrate such that the first transmission-line conductor is at a first offset distance with respect to the planar substrate and the second transmission-line conductor is at a different second offset distance with respect to the planar substrate.

8. The apparatus of claim 7,
wherein the first modulated electrical signal is in-phase with the third modulated electrical signal;
wherein the first transmission-line conductor is connected to carry the first modulated electrical signal; and
wherein the second transmission-line conductor is connected to carry the third modulated electrical signal.

9. The apparatus of claim 7, wherein the third and fourth transmission-line conductors are stacked vertically with respect to the planar substrate such that the third transmission-line conductor is at the first offset distance with respect to the planar substrate and the fourth transmission-line conductor is at the different second offset distance with respect to the planar substrate.

10. The apparatus of claim 9,
wherein the first modulated electrical signal is in-phase with the third modulated electrical signal;
wherein the second modulated electrical signal is in-phase with the fourth modulated electrical signal;
wherein the first and third modulated electrical signals are counter-phase with the second and fourth modulated electrical signals;
wherein the first transmission-line conductor is connected to carry the first modulated electrical signal;
wherein the second transmission-line conductor is connected to carry the third modulated electrical signal;
wherein the third transmission-line conductor is connected to carry the second modulated electrical signal; and
wherein the fourth transmission-line conductor is connected to carry the fourth modulated electrical signal.

11. The apparatus of claim 6, wherein the cathode side of the first optical waveguide core faces the cathode side of the second optical waveguide core.

12. The apparatus of claim 6, wherein the cathode side of the first optical waveguide core faces the anode side of the second optical waveguide core.

13. The apparatus of claim 6, wherein the anode side of the first optical waveguide core faces the anode side of the second optical waveguide core.

14. The apparatus of claim 6,
wherein the electrical driver includes a first capacitor and a second capacitor, the first capacitor being connected between the first and second transmission-line conductors, the second capacitor being connected between the third and fourth transmission-line conductors; and
wherein the first and second capacitors have respective capacitance values selected to at least partially compensate for a frequency roll-off in the optical modulator.

15. The apparatus of claim 14, wherein the electrical driver further includes a resistor bridge connected between the second and fourth transmission-line conductors.

16. The apparatus of claim 1,
wherein the first modulated electrical signal is applied to drive the cathode side of the second optical waveguide core;
wherein the second modulated electrical signal is applied to drive the cathode side of the first optical waveguide core;
wherein the third modulated electrical signal is applied to drive the anode side of the first optical waveguide core; and
wherein the fourth modulated electrical signal is applied to drive the anode side of the second optical waveguide core.

17. The apparatus of claim 1,
wherein the first modulated electrical signal is in-phase with the third modulated electrical signal;
wherein the second modulated electrical signal is in-phase with the fourth modulated electrical signal;
wherein the first and third modulated electrical signals are counter-phase with the second and fourth modulated electrical signals;
wherein the second and third modulated electrical signals are applied to the cathode and anode sides, respectively, of the first optical waveguide core; and
wherein the first and fourth modulated electrical signals are applied to the cathode and anode sides, respectively, of the second optical waveguide core.

18. An optical communication method, comprising:
providing an electrical driver for generating a first differential pair of modulated drive signals and a second differential pair of modulated drive signals in response to a data stream, the first pair including first and second modulated electrical signals, the second pair including third and fourth modulated electrical signals; and
configuring the electrical driver to apply the first, second, third, and fourth modulated electrical signals to an optical modulator including a first optical waveguide core and a second optical waveguide core, each of the first and second optical waveguide cores including a respective cathode side and a respective anode side joined to form a respective electrical diode,
wherein each of the first, second, third, and fourth modulated electrical signals is applied to a respective one of the cathode side of the first optical waveguide core, the anode side of the first optical waveguide core, the cathode side of the second optical waveguide core, and the anode side of the second optical waveguide core.

19. The method of claim 18,
wherein the optical modulator further includes:
first, second, third, and fourth transmission-line conductors disposed along the first and second optical waveguide cores and configured to drive the first and second optical waveguide cores in a travelling-wave configuration; and
a planar substrate;
wherein the first and second optical waveguide cores are disposed along the planar substrate; and
wherein the first and second transmission-line conductors are stacked vertically with respect to the planar substrate such that the first transmission-line conductor is at a first offset distance with respect to the planar substrate and the second transmission-line conductor is at a different second offset distance with respect to the planar substrate.

20. The method of claim 19, further comprising selecting one or more of the following design parameters to substantially minimize cross-mode excitation in the first and second transmission lines:
a width of one or both of the first and second transmission-line conductors;
a thickness of one or both of the first and second transmission-line conductors; and
vertical separation between the first and second transmission-line conductors.
